(19) United States
(12) Patent Application Publication
(10) Pub. No.: US 2025/0245610 A1
(43) Pub. Date: Jul. 31, 2025

(54) INFORMATION PROVISION APPARATUS, INFORMATION PROVISION SYSTEM, AND INFORMATION PROVISION METHOD

(71) Applicant: TOYOTA JIDOSHA KABUSHIKI KAISHA, Toyota-shi Aichi-ken (JP)

(72) Inventors: Tomiyasu ISHIKAWA, Okazaki-shi Aichi-ken (JP); Tadashi MATSUI, Kasugai-shi Aichi-ken (JP); Takumi KOZAWA, Nagoya-shi Aichi-ken (JP); Yuto MOTOYAMA, Nagoya-shi Aichi-ken (JP); Tsuyoshi OKADA, Nagoya-shi Aichi-ken (JP); Yoshiaki MASUYA, Inazawa-shi Aichi-ken (JP)

(73) Assignee: TOYOTA JIDOSHA KABUSHIKI KAISHA, Toyota-shi Aichi-ken (JP)

(21) Appl. No.: 19/037,992

(22) Filed: Jan. 27, 2025

(30) Foreign Application Priority Data
Jan. 29, 2024 (JP) 2024-011304

(51) Int. Cl. G06Q 10/0833; G06K 7/14; G06Q 10/0631; G06V 20/52

(52) U.S. Cl. CPC G06Q 10/0833; G06K 7/1417; G06Q 10/06311; G06V 20/52; G06V 2201/08

(57) ABSTRACT

An information provision apparatus includes a memory and a controller. The memory stores information on a vehicle stored in an automobile dealer before delivery to a purchaser, in association with identification information assigned to the vehicle. Upon accepting, from a purchaser terminal, an information request including the identification information, the controller generates or acquires schedule information including one or more processes that are scheduled up to the delivery, to the purchaser, of the vehicle to which the identification information is assigned, generates information for display to be displayed to the purchaser, and transmits the information for display to the purchaser terminal. The information for display includes information on a progress status in the one or more processes and information describing the one or more processes.

### CROSS-REFERENCE TO RELATED APPLICATION

This application claims priority to Japanese Patent Application No. 2024-011304, filed on Jan. 29, 2024, the entire contents of which are incorporated herein by reference.

### TECHNICAL FIELD

The present disclosure relates to an information provision apparatus, an information provision system, and an information provision method.

### BACKGROUND

Systems that provide users with information on the progress statuses of vehicles until delivery are known. For example, see Patent Literature (PTL) 1. A system of PTL 1 acquires information on the progress status of a specific vehicle corresponding to identification information, from among information on the progress statuses of multiple vehicles before delivery stored in a progress management DB, and provides the acquired information to a user terminal from which the identification information has been transmitted.

### CITATION LIST

### Patent Literature

PTL 1: JP 2002-297954 A

### SUMMARY

Conventional technology provides a purchaser who has purchased a vehicle with information on the progress status of the purchased vehicle in multiple stages until delivery. These multiple stages include captured images of the vehicle during assembly and transport, positional information thereon, and the like. This system, however, fails to provide the purchaser with a progress status in processes from arrival of the vehicle at a dealer, for the purpose of delivering the vehicle to the purchaser, up to the delivery of the vehicle to the purchaser. As a result, the purchaser may be frustrated and/or stressed by the time it takes to have the purchased vehicle delivered, even though the vehicle has already arrived at the dealer.

It would be helpful to reduce stress felt by purchasers who are waiting for delivery of vehicles.

An information provision apparatus according to an embodiment of the present disclosure includes:
a memory configured to store information on a vehicle stored in an automobile dealer before delivery to a purchaser, in association with identification information assigned to the vehicle; and
a controller configured to:
   upon accepting, from a purchaser terminal, an information request including the identification information, generate or acquire schedule information including one or more processes that are scheduled up to the delivery, to the purchaser, of the vehicle to which the identification information is assigned; and
   generate information for display to be displayed to the purchaser, and transmit the information for display to the purchaser terminal,
wherein the information for display includes information on a progress status in the one or more processes and information describing the one or more processes.

An information provision system according to an embodiment of the present disclosure includes:
an information provision apparatus including:
   a memory configured to store information on a vehicle stored in an automobile dealer before delivery to a purchaser, in association with identification information assigned to the vehicle; and
   a controller configured to:
      upon accepting, from a purchaser terminal, an information request including the identification information, generate or acquire schedule information including one or more processes that are scheduled up to the delivery, to the purchaser, of the vehicle to which the identification information is assigned; and
      generate information for display to be displayed to the purchaser, and transmit the information for display to the purchaser terminal,
   wherein the information for display includes information on a progress status in the one or more processes and information describing the one or more processes;
a vehicle identification apparatus located at a workplace in which at least one of the processes is executed, the vehicle identification apparatus being configured to be able to identify the vehicle; and
a camera configured to image the vehicle located at the workplace when the at least one of the processes is executed on the vehicle,
wherein when the vehicle identification apparatus has identified the vehicle, the controller is configured to store, in the memory, an image acquired from the camera, in association with the identification information on the vehicle.

An information provision method according to an embodiment of the present disclosure is a method performed by a controller of an information provision apparatus, the information provision method including:
storing, in a memory, information on a vehicle stored in an automobile dealer before delivery to a purchaser, in association with identification information assigned to the vehicle;
upon accepting, from a purchaser terminal, an information request including the identification information, generating or acquiring schedule information including one or more processes that are scheduled up to the delivery, to the purchaser, of the vehicle to which the identification information is assigned;
generating information for display to be displayed to the purchaser, and transmitting the information for display to the purchaser terminal,
wherein the information for display includes information on a progress status in the one or more processes and information describing the one or more processes.

According to the present disclosure, it is possible to reduce stress felt by purchasers who are waiting for delivery of vehicles.

### BRIEF DESCRIPTION OF THE DRAWINGS

In the accompanying drawings:

FIG. 1 is a block diagram illustrating a schematic configuration of an information provision system according to an embodiment of the present disclosure;

FIG. 2 is a block diagram illustrating a schematic configuration of an information provision apparatus of FIG. 1;

FIG. 3 is a diagram illustrating an example of arrangement of vehicles and apparatuses in an automobile dealer;

FIG. 4 is a diagram that illustrates identification of a vehicle by a vehicle identification apparatus;

FIG. 5 is a block diagram illustrating schematic configurations of a dealer terminal and a purchaser terminal of FIG. 1;

FIG. 6 is a diagram that illustrates schedule information on the vehicle before delivery;

FIG. 7 is a diagram illustrating an example of transition between images displayed on the purchaser terminal;

FIG. 8 is a diagram illustrating an example of a progress image displayed on the purchaser terminal;

FIG. 9 is a flowchart of processing in which the information provision apparatus provides information for display to the purchaser terminal; and

FIG. 10 is a flowchart of processing executed by the information provision apparatus when a process is executed on the vehicle.

### DETAILED DESCRIPTION

An embodiment of the present disclosure will be described below, with reference to the drawings. The drawings used in the following description are schematic. Dimensions, ratios, and the like on the drawings do not necessarily match actual ones.

### Overall Configuration

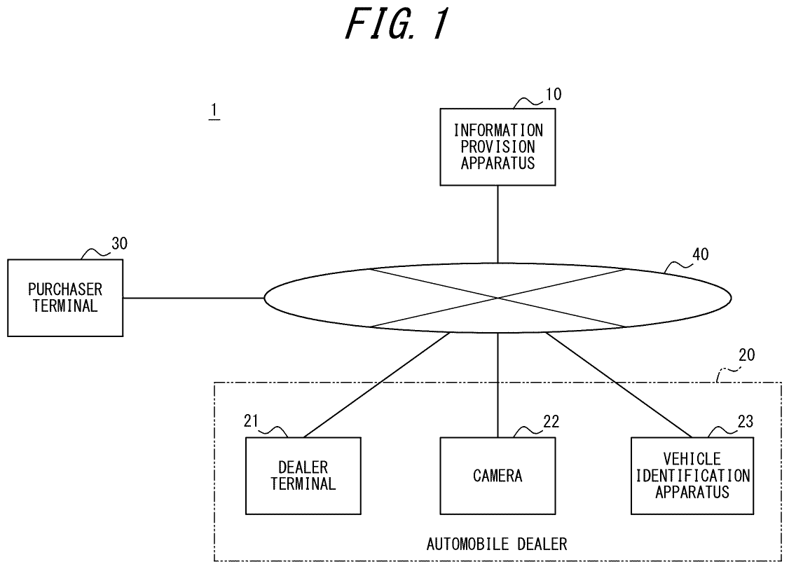

An information provision system 1 according to the present disclosure is a system for providing purchasers of vehicles at an automobile dealer 20 with progress information before delivery of the vehicles. The information provision system 1, as illustrated in FIG. 1 as an example, includes an information provision apparatus 10, a purchaser terminal 30, and a dealer terminal 21, a camera 22, and a vehicle identification apparatus 23, which are located at the automobile dealer 20. In FIG. 1, there is one component of each, but there may be multiple components of each. There may be multiple automobile dealers 20.

The components may be mutually communicable via a network 40. The network 40 may be a wide-area communication network including the Internet, for example. The dealer terminal 21, the camera 22, and the vehicle identification apparatus 23 in the automobile dealer 20 may be connected to the network 40 via a local area network (LAN) installed in the automobile dealer 20.

### (Configuration of Information Provision Apparatus)

The information provision apparatus 10 is a computer, e.g., a personal computer (PC) for a server. The information provision apparatus 10 stores and manages processes to be executed up to the delivery of the vehicles that are before the delivery. The information provision apparatus 10 generates information to be displayed on the dealer terminal 21 and the purchaser terminal 30, in response to information requests from the dealer terminal 21 and the purchaser terminal 30. The information provision apparatus 10 may be located on a cloud system or on a site of an automobile manufacturer associated with the automobile dealer 20. The information provision apparatus 10 may be configured so that a central server located in one location and a local server located at each dealer share functions. The information provision apparatus 10 may be located in each automobile dealer 20. When there are multiple information provision apparatuses 10 in the information provision system 1, the information provision apparatuses 10 may be able to mutually browse information and operate.

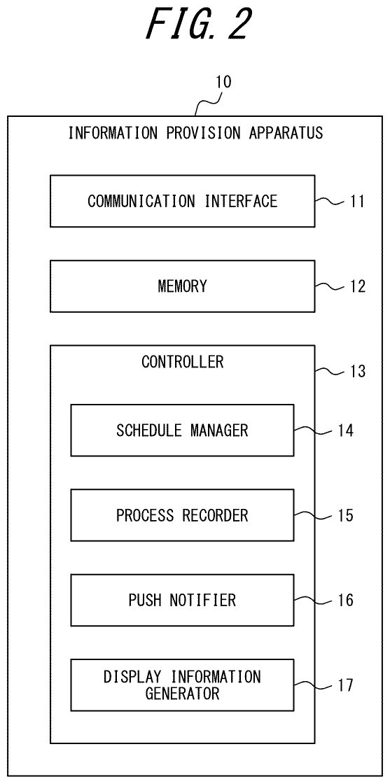

As illustrated in FIG. 2, the information provision apparatus 10 includes a communication interface 11, a memory 12, and a controller 13. The information provision apparatus 10 may further include an input interface for inputting information from the outside and an output interface for outputting information to the outside.

The communication interface 11 includes at least one interface for external communication for connecting to the network 40. The interface for external communication may be either a wired or wireless communication interface. For wired communication, the interface for communication is, for example, a Local Area Network (LAN) interface or Universal Serial Bus (USB). For wireless communication, the interface for communication is, for example, an interface corresponding to mobile communication standards, such as Long Term Evolution (LTE), 4th Generation (4G), or 5th Generation (5G). The communication interface 11 receives data to be used for operations of the information provision apparatus 10, and transmits data obtained by the operations of the information provision apparatus 10 to the outside (e.g., the dealer terminal 21 and the purchaser terminal 30).

The memory 12 includes at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM) or dynamic random access memory (DRAM). The ROM is, for example, electrically erasable programmable read only memory (EEPROM). The memory 12 functions as, for example, a main memory, an auxiliary memory, or a cache memory. The memory 12 stores programs and data to be used for the operations of the information provision apparatus 10 and data obtained by the operations of the information provision apparatus 10. The information stored in the memory 12 may be updated with, for example, information acquired from the network 40 via the communication interface 11. The memory 12 may store information on the vehicles, which are stored in the automobile dealer 20, prior to delivery to the purchasers, in association with identification information assigned to the vehicles.

The controller 13 includes at least one processor, at least one dedicated circuit, or a combination thereof. The processor is a general purpose processor, such as a central processing unit (CPU) or a graphics processing unit (GPU), or a dedicated processor specialized for particular processing. The dedicated circuit is, for example, a field-programmable gate array (FPGA) or an application specific integrated circuit (ASIC). The controller 13 executes processing related to the operations of the information provision apparatus 10 while controlling components of the information provision apparatus 10.

The controller 13 further includes functional blocks of a schedule manager 14, a process recorder 15, a push notifier 16, and a display information generator 17. Each functional block may be a hardware module or a software module. Processing executed by each functional block can be referred to as processing executed by the controller 13.

The schedule manager 14 manages an execution schedule of processes to be executed up to delivery of each vehicle, which is before the delivery to a purchaser, and the progress thereof. The processes managed by the schedule manager 14 include registration of the vehicle with an official organization, installation of each optional part, inspection and maintenance, and the like.

The process recorder 15 acquires and manages record information that records execution of each process prior to delivery of a vehicle when the process is executed. The record information is, for example, moving and still images captured during the execution of the process.

The push notifier 16 transmits, when a process is executed on a vehicle, a notification to a purchaser terminal 30 owned by a purchaser, in a case in which the purchaser desires. The push notifier 16 may automatically determine, in cooperation with the vehicle identification apparatus 23, the execution of the process. The push notifier 16 may transmit, at a desire of the purchaser, an image during the execution of the process in real time to the purchaser terminal 30.

Upon accepting, from a purchaser terminal 30, an information request including identification information on a vehicle, the display information generator 17 generates information for display to a purchaser of the vehicle to which the identification information is assigned, and transmits the information for display to the purchaser terminal 30. The information for display includes one or more processes that are scheduled up to delivery and progress information thereon. This allows the purchaser to check, on the purchaser terminal 30, the processes scheduled up to the delivery and the progress thereof.

In the following, processing executed by the functional blocks of the schedule manager 14, the process recorder 15, the push notifier 16, and the display information generator 17 is described as processing executed by the controller 13.

### (Automobile Dealer)

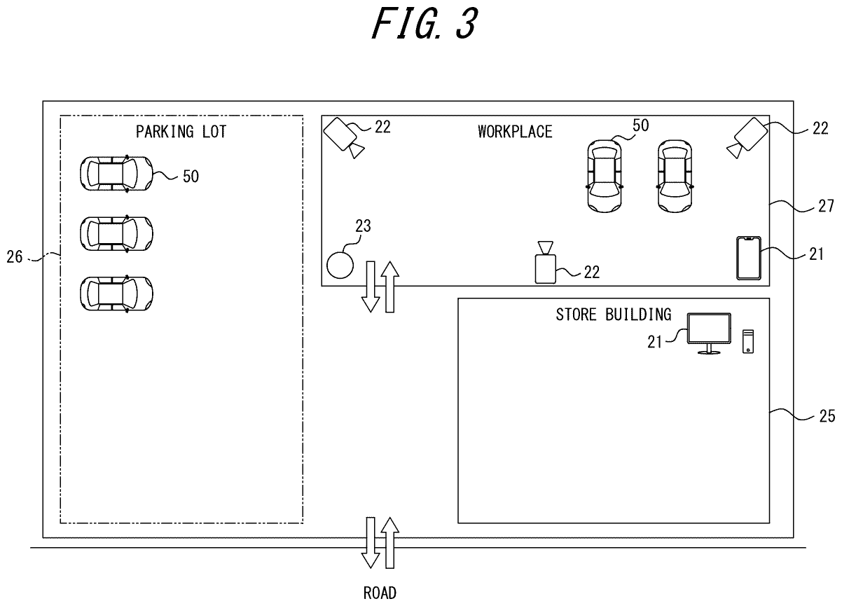

The automobile dealer 20 according to the present disclosure provides information on new vehicles to purchasers, conducts business negotiations, concludes sales contracts, places orders with the automobile manufacturer, receives completed vehicles, and delivers the vehicles to the purchasers. Typically, as illustrated in FIG. 3, the automobile dealer 20 has a store building 25, a parking lot 26, and a workplace 27, in a site facing a road. The store building 25 is where the automobile dealer 20 conducts business negotiations with visitors, and also serves as office space for the automobile dealer 20. The parking lot 26 has parking spaces for the visitors' vehicles and vehicles 50 including the vehicles before the delivery to the purchasers. The workplace 27 is where processes, such as installation of optional parts and inspection and maintenance, are executed on the vehicles 50 before the delivery. The workplace 27 is also referred to as “pit”.

In the store building 25 and the workplace 27, the dealer terminals 21 may be disposed. The dealer terminals 21 may be PCs, tablet terminals, or the like. In the workplace 27, one or more cameras 22 and a vehicle identification apparatus 23 may be located. The cameras 22 are located at appropriate positions in the workplace 27 so that vehicles 50 undergoing execution of processes in the workplace 27 can be imaged.

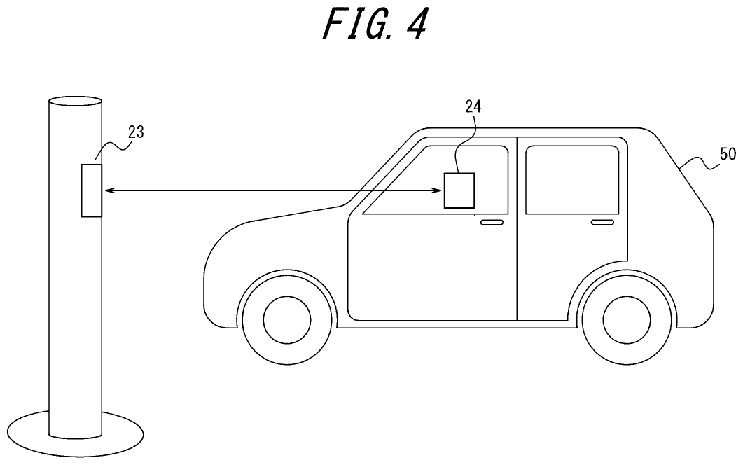

The vehicle identification apparatus 23 is an apparatus that identifies the vehicles 50. As illustrated in FIG. 4, the vehicle identification apparatus 23 can read identification information from an identification information carrier 24 attached to each vehicle 50. For example, the identification information carrier 24 can be a radio frequency identification (RFID) tag, and the vehicle identification apparatus 23 can be an RFID reader. For example, the identification information carrier 24 can be a two-dimensional code, and the vehicle identification apparatus 23 can be a camera. The identification information carrier 24 may be attached to each vehicle 50 before delivery. When a vehicle 50 has entered the workplace 27, the entry of the vehicle 50 to the workplace 27 may be automatically determined.

### (Configuration of Dealer Terminal/Purchaser Terminal)

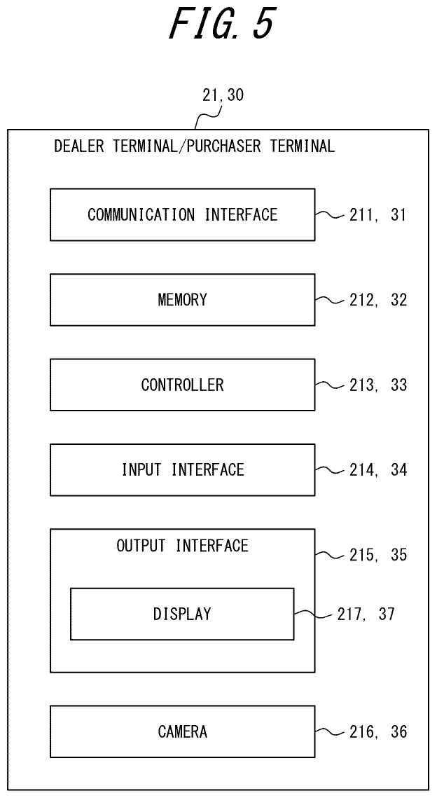

The dealer terminal 21 and the purchaser terminal 30 are computers such as PCs, smartphones, or tablet terminals. As the dealer terminal 21 and the purchaser terminal 30, general purpose apparatuses can be used. As illustrated in FIG. 5, the dealer terminal 21 may include a communication interface 211, a memory 212, a controller 213, an input interface 214, an output interface 215, and a camera 216. The purchaser terminal 30 may include a communication interface 31, a memory 32, a controller 33, an input interface 34, an output interface 35, and a camera 36.

As with the communication interface 11 of the information provision apparatus 10, the communication interface 211, 31 includes at least one interface for external communication for connecting to the network 40.

As with the memory 12 of the information provision apparatus 10, the memory 212, 32 includes at least one semiconductor memory, at least one magnetic memory, at least one optical memory, or a combination of at least two of these. The memory 212, 32 may store an application for retrieving and displaying information from the information provision apparatus 10. The dealer terminal 21 and the purchaser terminal 30 may be equipped with the same application or different applications. In the application of the purchaser terminal 30, some of operations that can be executed in the application of the dealer terminal 21 and part of information that can be displayed in the application of the dealer terminal 21 may be limited.

As with the controller 13 of the information provision apparatus 10, the controller 213, 33 may include at least one processor, at least one dedicated circuit, or a combination thereof. The controller 213 can activate the application stored in the memory 212 to thereby operate the dealer terminal 21 as a terminal of the information provision system 1. The controller 33 can activate the application stored in the memory 32 to thereby operate the purchaser terminal 30 as a terminal of the information provision system 1.

The input interface 214 accepts inputs to the dealer terminal 21. The input interface 34 accepts inputs to the purchaser terminal 30. The input interface 214, 34 may include, for example, a keyboard, a mouse, a touch panel, and a microphone that accepts voice input.

The output interface 215 outputs information processed by the dealer terminal 21 to a user. The output interface 35 outputs information processed by the purchaser terminal 30 to a user. The output interface 215 includes a display 217. The output interface 35 includes a display 37. The output interface 215, 35 may further include a speaker.

The display 217 is a device that displays images obtained as a result of processing by the controller 213. The display 37 is a device that displays images obtained as a result of processing by the controller 33. The display 217, 37 may be selected from various types of displays, e.g., a liquid crystal display (LCD), an organic electro-luminescence (EL) display, an inorganic EL display, a plasma display panel (PDP), and the like. The display 217, 37 can display progress information provided by the information provision apparatus 10 and still and moving images related thereto.

The camera 216, 36 captures images, including still and moving images. The camera 216 is not a required component of the dealer terminal 21. The camera 36 is not a required component of the purchaser terminal 30. However, the provision of the camera 216 in the dealer terminal 21 allows workers at the automobile dealer to capture images of vehicles 50 after being worked on. For example, when a license plate is newly installed to a vehicle 50, a worker may capture an image of the license plate using the camera 216.

### (Schedule Information)

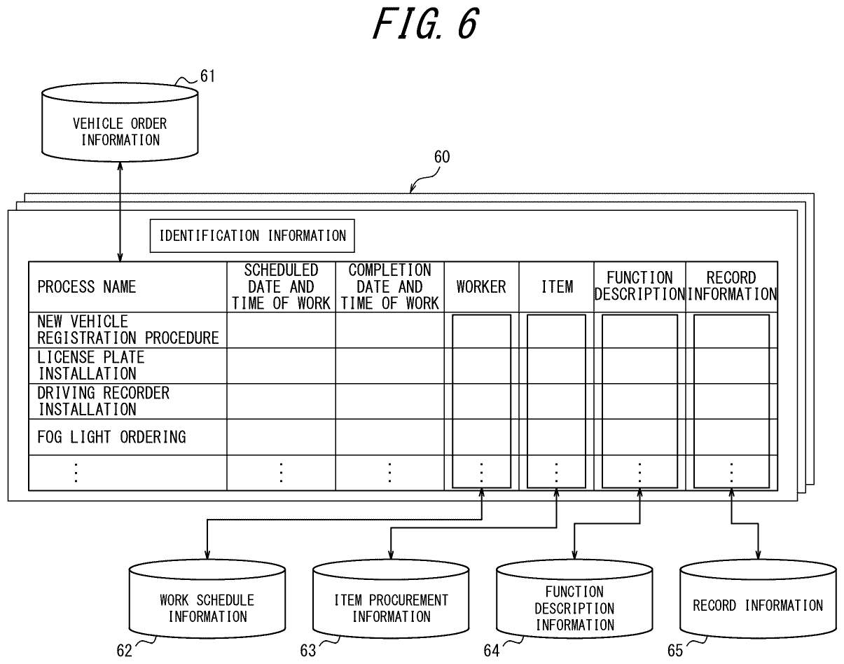

The controller 13 of the information provision apparatus 10 can acquire or generate schedule information 60 for each vehicle 50, which is before delivery to a purchaser, identified by identification information. As illustrated in FIG. 6, the schedule information 60 includes, for example, the names of processes to be executed at the automobile dealer 20 prior to the delivery to the purchaser. In the example of FIG. 6, the process names correspond to “new vehicle registration procedure,” “license plate installation,” “driving recorder installation,” and “fog light ordering.”

When generating the schedule information 60, the controller 13 extracts standard processes required prior to delivery of vehicles, such as vehicle registration procedure and license plate installation. In addition, the schedule manager 14 extracts, from vehicle order information 61 stored in the information provision apparatus 10 or in another device, processes required prior to the delivery of the vehicle 50. The vehicle order information 61 includes information on optional parts to be installed to the vehicle 50 and services to be added to the vehicle 50 under contract with the purchaser.

The schedule information 60 may further include information on, for each process, a scheduled date and time of work, a completion date and time of completed work, a worker responsible, and a required item. The required item includes, for example, information on the availability of an optional part, in the case of installation of the optional part. The controller 13 may determine the scheduled date and time of work to ensure that a worker is assigned and the required item is secured. Thus, the controller 13 is configured to be able to browse and operate work schedule information 62 to manage schedules of workers, and item procurement information 63 to manage the procurement statuses of items, which are stored in the information provision apparatus 10 or in another device.

The schedule information 60 may also contain link information to function description information 64 associated with each process. The function description information 64 may be stored in the memory 12 of the information provision apparatus 10. The function description information 64 includes, for example, a function description image provided as a moving image. For example, the process name “driving recorder installation” may be associated with a moving image that summarizes the functions and convenience of a driving recorder. The link information may be, for example, a pointer to a file in the memory 12 in which the function description information 64 is stored. The controller 13 is configured to, upon accepting, from a purchaser terminal 30, a request for information on function description of each process, transmit the function description information 64, which is, for example, the function description image, to the purchaser terminal 30.

In addition, the schedule information 60 may contain link information to record information 65, such as a record image captured by the camera 22 during execution of each process. The controller 13 acquires and manages the record information 65. The link information may be, for example, a pointer to a moving image file in the memory 12 in which the record information 65 is stored. The controller 13 is configured to, upon accepting, from a purchaser terminal 30, a request for information on a recorded image and other recorded information on a completed process, transmit the record information 65 to the purchaser terminal 30. For example, when a purchaser requests, from a purchaser terminal 30, the record information 65 on “driving recorder installation”, the controller 13 can transmit, to the purchaser terminal 30, a moving image captured during execution of “driving recorder installation” on a vehicle 50 of the purchaser.

Upon accepting, from a purchaser terminal 30, a request for displaying progress information on processes of a vehicle 50 purchased by a purchaser, the controller 13 of the information provision apparatus 10 generates information for display from part of information contained in the schedule information 60 and transmits the information for display to the purchaser terminal 30. The controller 13 can make, for example, as specified by the dealer terminal 21, part of processes managed by the automobile dealer 20 as non-viewable processes that are not included in the information for display to be transmitted to the purchaser terminal 30. For example, the processes managed by the automobile dealer 20 can include a process waiting for arrival of a part and a process in a state waiting for allocation of a man-hours. These processes do not need to be displayed to the purchaser, as the non-viewable processes.

In FIG. 6, for example, the process of “fog light ordering” can be included as a process to be executed at the automobile dealer 20 when the automobile dealer 20 does not have a fog light that the purchaser has contracted for as an optional part. However, the automobile dealer 20 may not want to notify the purchaser that the fog light has been ordered and is awaiting delivery. Therefore, such processes related to ordering items or assigning personnel at the automobile dealer 20 can be made as the non-viewable processes.

On the other hand, the controller 13 may make information on the non-viewable processes viewable from the dealer terminals 21 provided at the automobile dealer 20. The information on the non-viewable processes may be made shareable with different automobile dealers 20. This makes it possible to accommodate man-hours and/or short items among multiple automobile dealers 20. This promotes execution of processes and reduces the time involved in delivering vehicles to purchasers.

### Example of Display on Purchaser Terminal

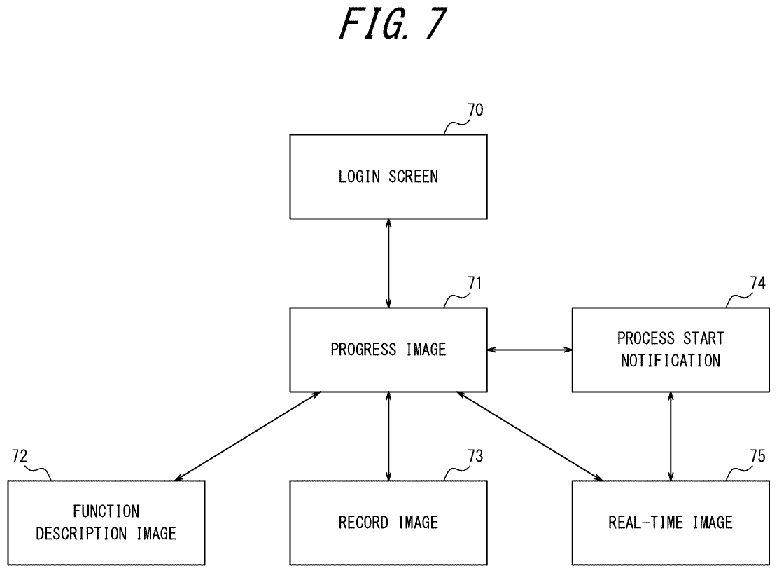

Contents displayed on a purchaser terminal 30 when using the information provision system 1 will be described with reference to FIG. 7. The same display can be made for the dealer terminals 21. First, when a purchaser of a vehicle 50 starts up the application of the information provision system 1 on a purchaser terminal 30, a login screen 70 that asks for entries of a purchaser ID and a password is displayed on the display 37. After the purchaser ID and the password are entered, a progress image 71 that indicates processes up to delivery of the vehicle 50 is displayed on the display 37.

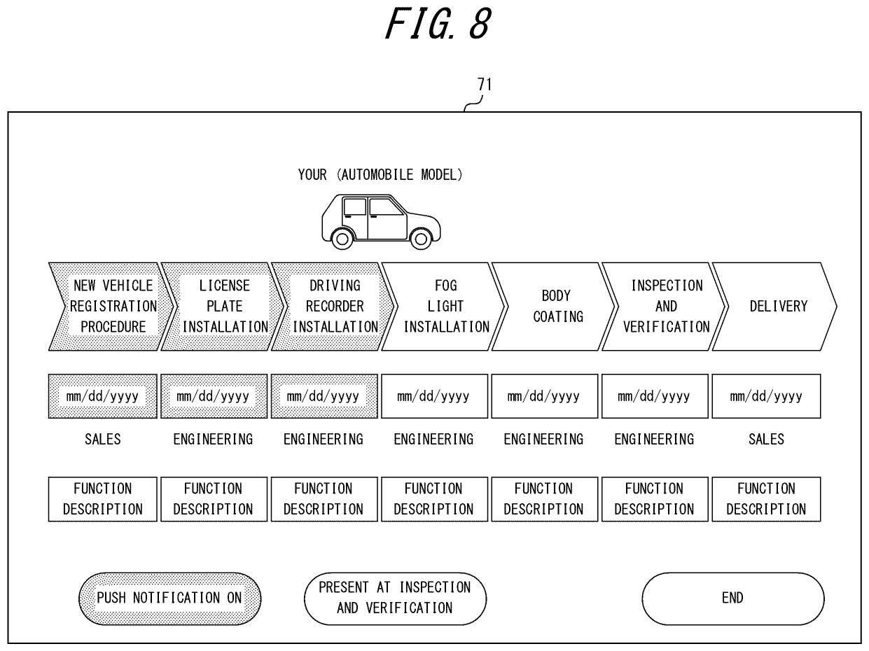

For example, as illustrated in FIG. 8, the progress image 71 displays the name of each process up to the delivery of the vehicle 50 in a box (image element) indicating a chronological direction. In the example of FIG. 8, seven processes, i.e., “new vehicle registration procedure,” “license plate installation,” “driving recorder installation,” “fog light installation,” “body coating,” “inspection and verification,” and “delivery.” Uncompleted processes that are about to be executed and completed processes that have already been completed are displayed in an easy-to-understandable and easy-to-distinguishable manner by changing the colors of the boxes or other techniques. In the example of FIG. 8, the processes up to “driving recorder installation” are completed, and the processes after “fog light installation” are not yet completed. At the top of the boundary between the boxes representing the completed processes and the boxes representing the uncompleted processes, an image of the vehicle 50 purchased by the purchaser may be displayed. This allows the purchaser to sensuously grasp which stage the vehicle 50 is currently at in preparation for the delivery of the vehicle 50.

For each completed process, when the box with the name of the process is pressed, as illustrated in FIG. 7, a record image 73, which is a moving or still image captured during execution of the process, is displayed on the display 37. This allows the purchaser to confirm by images that the processes are proceeding in preparation for the delivery. This also increases the purchaser's anticipation for the delivery of the vehicle 50.

Under each process, a date or date and time the process is scheduled to be executed is displayed for the uncompleted processes, and a date or date and time the process has been completed for the completed processes. In a further lower portion of each process, the type of a person in charge of the process may be indicated. The type of the person in charge is indicated as, for example, sales staff or engineering staff.

In addition, under the box indicating each process, a button to activate a function description of the process may be disposed. By pressing this button, as illustrated in FIG. 7, a function description image 72, which is a moving or still image associated with the respective process, is displayed. By displaying the function description image 72, the information provision system 1 can provide the purchaser with a sense of satisfaction about the occurrence of waiting time involved in the execution of the processes.

In addition, the progress image 71 of the FIG. 8 may be provided with a push notification button, which is a button to select whether the information provision system 1 actively notifies the purchaser of the execution of the processes. When the purchaser has turned on the push notification button, as illustrated in FIG. 7, a process start notification 74, which notifies the purchaser that a process is about to start, may be displayed, upon starting the execution of the process on the vehicle 50 of the purchaser at the automobile dealer 20. The process start notification 74 may be displayed on the purchaser terminal 30 in a pop-up window or the like. The process start notification 74 may be set to be displayed even when the purchaser does not open the progress image 71.

The start of the execution of the process may be automatically determined by the information provision apparatus 10 when the vehicle identification apparatus 23 detects that the vehicle 50 purchased by the purchaser has entered the workplace 27, by receiving this information by the information provision apparatus 10 and matching the information against the schedule information. The start of the execution of the process may be entered by a person in charge at the automobile dealer 20 by operating the dealer terminal 21.

The process start notification 74 may include, for example, a message such as “Fog light installation is starting. Would you like to view a moving image?”. In addition, the process start notification 74 may display a button to select “Yes” or “No.” When the purchaser selects to view the moving image, a real-time image 75 captured by the camera 22 in the workplace 27 is transmitted to the purchaser terminal 30 and displayed on the display 37.

The progress image 71 of the FIG. 8 may also display a button indicating whether the purchaser desires to be present at the inspection and verification process that takes place before the delivery of the vehicle 50. When the purchaser desires to be present at the inspection and verification process, a notification inviting the purchaser to be present may be transmitted from the information provision apparatus 10 to the purchaser terminal 30 upon fixing a date and time for the inspection and verification process.

### (Information Display Processing for Purchaser Terminal)

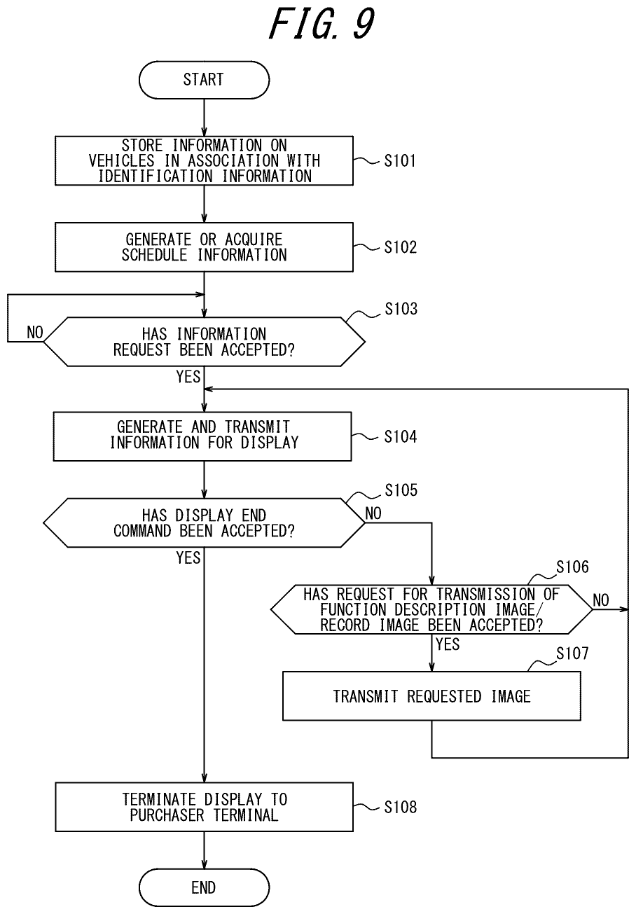

Next, processing in which the controller 13 of the information provision apparatus 10 provides information for display to a purchaser terminal 30 will be described with reference to FIG. 9.

First, the controller 13 stores information on multiple vehicles 50, in association with identification information on each vehicle 50 (S101). The information on the multiple vehicles 50 includes the vehicle order information 61. The vehicle order information 61 includes information on optional equipment for each vehicle 50. The identification information for each vehicle 50 is associated with a purchaser of the vehicle 50.

The controller 13 generates or acquires schedule information up to delivery of each vehicle 50 (S102). The schedule information may be generated in the information provision apparatus 10, or may be generated in another device and acquired from the device. The schedule information is managed by the controller 13 until the delivery of each vehicle 50. The generation and acquisition of the schedule information in S102 may be executed when an information request is accepted from a purchaser terminal in S103.

Upon accepting, from a purchaser terminal 30, an information request including identification information on a vehicle 50 of a purchaser (S103), the controller 13 acquires the schedule information generated in S102, generates information for display on the display 37 of the purchaser terminal 30, and transmits the information for display to the purchaser terminal 30 (S104). However, when the schedule information includes non-viewable processes, the controller 13 does not transmit information on the non-viewable processes to the purchaser terminal 30. The controller 13 transmits, to the purchaser terminal 30, the information for displaying to display a progress image 71 illustrated in FIG. 8, for example. This causes the purchaser terminal 30 to display the progress image 71.

With the progress image 71 displayed (S105: No), when the purchaser operates, from the progress image 71, to display a function description image 72 or a record image 73, the purchaser terminal 30 transmits, to the information provision apparatus 10, a request for transmission of the function description image 72 or the record image 73. Upon accepting the request for transmission of the function description image 72 or the record image 73 (S106: Yes), the controller 13 transmits, to the purchaser terminal 30, the function description image 72 or the record image 73 stored in the memory 12 (S107). These images may be displayed in a streaming method on the display 37 of the purchaser terminal 30.

When not accepting a request for transmission of the function description image 72 or the record image 73 (S106: No), the controller 13 continues to display the progress image 71. The image displayed by the controller 13 on the purchaser terminal 30 may be updated when there is a change in a process execution state or periodically. Upon completing the transmission of the requested image to the purchaser terminal 30 (S107), the controller 13 generates and transmits the information for display to display the progress image 71 again on the purchaser terminal 30 (S104).

When the purchaser indicates an end of the display by, for example, pressing an end button on the progress image 71 while the progress image 71 is being displayed on the purchaser terminal 30, a display end command is transmitted to the information provision apparatus 10. Upon accepting the display end command (S105: Yes), the controller 13 terminates the display of the purchaser terminal 30 (S108). The controller 33 of the purchaser terminal 30 also terminates processing of the application.

### (Processing When Process Is Executed)

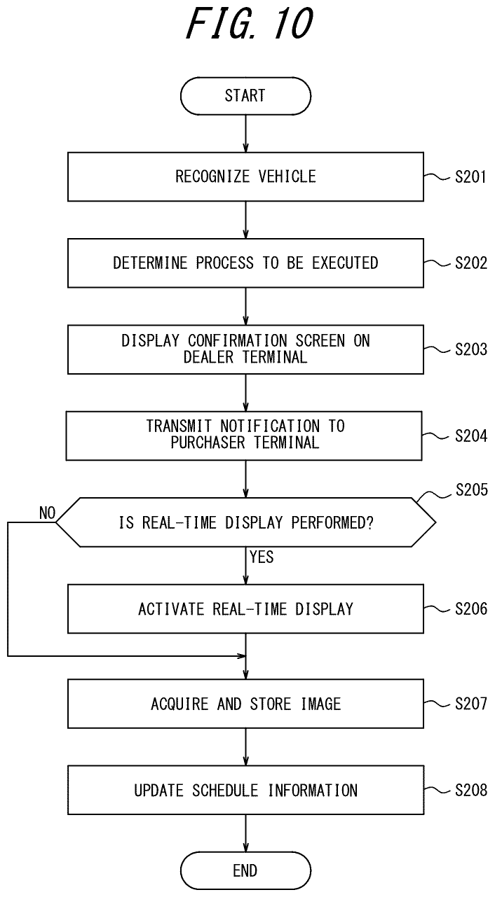

The controller 13 of the information provision apparatus 10 manages process execution states before delivery of the vehicles 50. FIG. 10 is a flowchart illustrating processing performed by the controller 13 when a process is executed on a vehicle 50. The process to be executed is a process of installation of optional parts executed at the workplace 27.

First, when a vehicle 50 enters the workplace 27, the vehicle identification apparatus 23 identifies the vehicle 50 and notifies the information provision apparatus 10. This causes the controller 13 to recognize the vehicle 50 on which a process is about to be executed (S201).

Next, the controller 13 checks schedule information for the vehicle 50 to determine which process is about to be executed (S202).

Upon determining the process that is about to be executed, the controller 13 displays a confirmation screen on the dealer terminal 21 (S203). The confirmation screen includes the name of the process about to be executed. In the confirmation screen, whether to notify a purchaser of the execution of the process can be selected. This enables the automobile dealer 20 not to display processes that purchasers do not need to view. In the following description, the purchaser is notified of the execution of the process. S203 is not required, and the controller 13 may always transmit a notification to the purchaser when the process is executed.

Note that, S201 and S202 above assume that the information provision apparatus 10 automatically determines that the process is about to be executed. However, information on the execution of the process may be entered by a worker at the automobile dealer 20 operating the same or different dealer terminal 21 as or from the one used in step S103.

The controller 13 notifies the purchaser terminal 30 that the process is about to start (S204). Upon accepting the notification from the controller 13, the purchaser terminal 30 displays a process start notification 74 and prompts the purchaser to select whether to display a process execution state in real time.

Upon accepting, from the purchaser terminal 30, a selection result for real-time display (S205: Yes), the controller 13 activates real-time transmission of an image captured by the camera 22 (S206). Thus, a real-time image 75 is displayed on the display 37 of the purchaser terminal 30. The latest information on the vehicle 50 can be thereby provided as an image, such as a moving image, to the purchaser who is eagerly awaiting delivery of the vehicle 50.

The controller 13 stores, in the memory 12, the image of the process captured by the camera 22 as a record image 73 (S207), regardless of whether the controller 13 accepts the selection result for real-time display from the purchaser terminal 30 (S205: Yes) or not (S205: No). This enables the purchaser to view the record image 73 from the purchaser terminal 30 after the process is completed.

When the process is completed, the controller 13 updates the schedule information 60 (S208). Specifically, the controller 13 registers a completion date and time of work for the completed process and a link to the record image 73.

As described above, according to the present embodiment, the information provision apparatus 10 has, as information to be displayed to purchasers, information on the progress of processes including record images 73, and information describing the processes including function description images 72. Therefore, the information provision system 1 can provide the purchasers with a sense of satisfaction for waiting time that is required before delivery of vehicles 50, thereby reducing stress felt by the purchasers waiting for the delivery of the vehicles 50.

It should be noted that the present disclosure is not limited to the above embodiment, and various modifications and revisions can be implemented. For example, functions or the like included in each element, each step, or the like can be rearranged without logical inconsistency, and a plurality of elements, steps, or the like can be combined into one or divided. The embodiment according to the present disclosure may also be implemented as a method or program executed by a processor provided in the information provision apparatus 10. These are also encompassed within the scope of the present disclosure. The program can be stored in a non-transitory computer readable medium. Examples of the non-transitory computer readable media may include, but are not limited to, a hard disk, RAM, ROM, flash memory, a CD-ROM, an optical storage device, and a magnetic storage device.

Examples of some embodiments of the present disclosure are described below. However, it should be noted that the embodiments of the present disclosure are not limited to these examples.

[Appendix 1] An information provision apparatus comprising:
a memory configured to store information on a vehicle stored in an automobile dealer before delivery to a purchaser, in association with identification information assigned to the vehicle; and
a controller configured to:
   upon accepting, from a purchaser terminal, an information request including the identification information, generate or acquire schedule information including one or more processes that are scheduled up to the delivery, to the purchaser, of the vehicle to which the identification information is assigned; and
   generate information for display to be displayed to the purchaser, and transmit the information for display to the purchaser terminal,
wherein the information for display includes information on a progress status in the one or more processes and information describing the one or more processes.
   [Appendix 2] The information provision apparatus according to appendix 1, wherein the controller is configured to:
when a process included in the one or more processes is executed, acquire record information recording execution of the process, and store the record information in the memory in association with the process; and
when an information request for the record information is accepted from the purchaser terminal, transmit the record information to the purchaser terminal.
   [Appendix 3] The information provision apparatus according to appendix 2, wherein the record information includes a moving image and/or a still image captured during the execution of the process.
   [Appendix 4] The information provision apparatus according to appendix 3, wherein the moving image and/or the still image include an image of the vehicle that is associated with the identification information.
   [Appendix 5] The information provision apparatus according to appendix 4, wherein the controller is configured to:
be able to acquire identification information for a vehicle from a vehicle identification apparatus located at a workplace in which the process is executed;
be able to acquire an image from a camera located at the workplace; and
store, in the memory, the image acquired from the camera, as the moving image and/or the still image of the vehicle identified by the identification information.
   [Appendix 6] The information provision apparatus according to any one of appendices 1 to 5, wherein the controller is configured to make part of the one or more processes, as one or more non-viewable processes that are not included in the information for display to be transmitted to the purchaser terminal.
   [Appendix 7] The information provision apparatus according to appendix 6, wherein the one or more non-viewable processes that are not included in the information for display include a process of waiting for arrival of a part and/or a process in a state waiting for allocation of a man-hour.
   [Appendix 8] The information provision apparatus according to appendix 6 or 7, wherein the controller is configured to:
make information on the one or more non-viewable processes viewable from a dealer terminal provided at the automobile dealer; and
make the information on the one or more non-viewable processes sharable with a different automobile dealer.
   [Appendix 9] The information provision apparatus according to any one of appendices 1 to 8, wherein
the memory is configured to store information on function description associated with each process of the one or more processes, and
the controller is configured to transmit the information on the function description to the purchaser terminal upon accepting, from the purchaser terminal, a request for the information on the function description of the one or more processes.
   [Appendix 10] An information provision system comprising:
an information provision apparatus comprising:
   a memory configured to store information on a vehicle stored in an automobile dealer before delivery to a purchaser, in association with identification information assigned to the vehicle; and
   a controller configured to:
      upon accepting, from a purchaser terminal, an information request including the identification information, generate or acquire schedule information including one or more processes that are scheduled up to the delivery, to the purchaser, of the vehicle to which the identification information is assigned; and
      generate information for display to be displayed to the purchaser, and transmit the information for display to the purchaser terminal,
   wherein the information for display includes information on a progress status in the one or more processes and information describing the one or more processes;
a vehicle identification apparatus located at a workplace in which at least one of the processes is executed, the vehicle identification apparatus being configured to be able to identify the vehicle; and
a camera configured to image the vehicle located at the workplace when the at least one of the processes is executed on the vehicle,
wherein when the vehicle identification apparatus has identified the vehicle, the controller is configured to store, in the memory, an image acquired from the camera, in association with the identification information on the vehicle.
   [Appendix 11] The information provision system according to appendix 10, wherein the vehicle identification apparatus is configured with an RFID reader that reads an RFID attached to the vehicle, or a camera that reads a two-dimensional code attached to the vehicle.
   [Appendix 12] The information provision system according to appendix 10 or 11, wherein the controller is configured to, when the vehicle has been identified, determine which of the one or more processes is to be executed, based on the schedule information on the identified vehicle.
   [Appendix 13] The information provision system according to any one of appendices 10 to 12, wherein the controller is configured to, when the vehicle has been identified, be able to transmit a notification to the purchaser terminal of the purchaser of the identified vehicle.
   [Appendix 14] The information provision system according to appendix 13, wherein the controller is configured to, before transmitting the notification, transmit a signal to display a transmission availability selection screen to a dealer terminal provided at the automobile dealer.
   [Appendix 15] The information provision system according to any one of appendices 10 to 14, wherein the controller is configured to be able to transmit, in real time, the image acquired from the camera to the purchaser terminal.
   [Appendix 16] The information provision system according to any one of appendices 10 to 15, wherein the controller is configured to make part of the one or more processes, as one or more non-viewable processes that are not included in the information for display to be transmitted to the purchaser terminal.
   [Appendix 17] The information provision system according to appendix 16, wherein the one or more non-viewable processes that are not included in the information for display include a process of waiting for arrival of a part and/or a process in a state waiting for allocation of a man-hour.
   [Appendix 18] The information provision system according to appendix 16 or 17, wherein the controller is configured to:
make information on the one or more non-viewable processes viewable from a dealer terminal provided at the automobile dealer; and
make the information on the one or more non-viewable processes sharable with a different automobile dealer.
   [Appendix 19] The information provision system according to any one of appendices 10 to 18, wherein
the memory is configured to store information on function description associated with each process of the one or more processes, and
the controller is configured to transmit the information on the function description to the purchaser terminal upon accepting, from the purchaser terminal, a request for the information on the function description of the one or more processes.
   [Appendix 20] An information provision method performed by a controller of an information provision apparatus, the information provision method comprising:
storing, in a memory, information on a vehicle stored in an automobile dealer before delivery to a purchaser, in association with identification information assigned to the vehicle;
upon accepting, from a purchaser terminal, an information request including the identification information, generating or acquiring schedule information including one or more processes that are scheduled up to the delivery, to the purchaser, of the vehicle to which the identification information is assigned;
generating information for display to be displayed to the purchaser, and transmitting the information for display to the purchaser terminal,
wherein the information for display includes information on a progress status in the one or more processes and information describing the one or more processes.

1. An information provision apparatus comprising:
a memory configured to store information on a vehicle stored in an automobile dealer before delivery to a purchaser, in association with identification information assigned to the vehicle; and
a controller configured to:
upon accepting, from a purchaser terminal, an information request including the identification information, generate or acquire schedule information including one or more processes that are scheduled up to the delivery, to the purchaser, of the vehicle to which the identification information is assigned; and
generate information for display to be displayed to the purchaser, and transmit the information for display to the purchaser terminal,
wherein the information for display includes information on a progress status in the one or more processes and information describing the one or more processes.

2. The information provision apparatus according to claim 1, wherein the controller is configured to:
when a process included in the one or more processes is executed, acquire record information recording execution of the process, and store the record information in the memory in association with the process; and
when an information request for the record information is accepted from the purchaser terminal, transmit the record information to the purchaser terminal.

3. The information provision apparatus according to claim 2, wherein the record information includes a moving image and/or a still image captured during the execution of the process.

4. The information provision apparatus according to claim 3, wherein the moving image and/or the still image include an image of the vehicle that is associated with the identification information.

5. The information provision apparatus according to claim 4, wherein the controller is configured to:
be able to acquire identification information for a vehicle from a vehicle identification apparatus located at a workplace in which the process is executed;
be able to acquire an image from a camera located at the workplace; and
store, in the memory, the image acquired from the camera, as the moving image and/or the still image of the vehicle identified by the identification information.

6. The information provision apparatus according to claim 1, wherein the controller is configured to make part of the one or more processes, as one or more non-viewable processes that are not included in the information for display to be transmitted to the purchaser terminal.

7. The information provision apparatus according to claim 6, wherein the one or more non-viewable processes that are not included in the information for display include a process of waiting for arrival of a part and/or a process in a state waiting for allocation of a man-hour.

8. The information provision apparatus according to claim 6, wherein the controller is configured to:
make information on the one or more non-viewable processes viewable from a dealer terminal provided at the automobile dealer; and
make the information on the one or more non-viewable processes sharable with a different automobile dealer.

9. The information provision apparatus according to claim 1, wherein
the memory is configured to store information on function description associated with each process of the one or more processes, and
the controller is configured to transmit the information on the function description to the purchaser terminal upon accepting, from the purchaser terminal, a request for the information on the function description of the one or more processes.

10. An information provision system comprising:
an information provision apparatus comprising:
a memory configured to store information on a vehicle stored in an automobile dealer before delivery to a purchaser, in association with identification information assigned to the vehicle; and
a controller configured to:
upon accepting, from a purchaser terminal, an information request including the identification information, generate or acquire schedule information including one or more processes that are scheduled up to the delivery, to the purchaser, of the vehicle to which the identification information is assigned; and
generate information for display to be displayed to the purchaser, and transmit the information for display to the purchaser terminal,
wherein the information for display includes information on a progress status in the one or more processes and information describing the one or more processes;
a vehicle identification apparatus located at a workplace in which at least one of the processes is executed, the vehicle identification apparatus being configured to be able to identify the vehicle; and
a camera configured to image the vehicle located at the workplace when the at least one of the processes is executed on the vehicle,
wherein when the vehicle identification apparatus has identified the vehicle, the controller is configured to store, in the memory, an image acquired from the camera, in association with the identification information on the vehicle.

11. The information provision system according to claim 10,
wherein the vehicle identification apparatus is configured with an RFID reader that reads an RFID attached to the vehicle, or a camera that reads a two-dimensional code attached to the vehicle.

12. The information provision system according to claim 10, wherein the controller is configured to, when the vehicle has been identified, determine which of the one or more processes is to be executed, based on the schedule information on the identified vehicle.

13. The information provision system according to claim 10, wherein the controller is configured to, when the vehicle has been identified, be able to transmit a notification to the purchaser terminal of the purchaser of the identified vehicle.

14. The information provision system according to claim 13, wherein the controller is configured to, before transmitting the notification, transmit a signal to display a transmission availability selection screen to a dealer terminal provided at the automobile dealer.

15. The information provision system according to claim 10, wherein the controller is configured to be able to transmit, in real time, the image acquired from the camera to the purchaser terminal.

16. The information provision system according to claim 10, wherein the controller is configured to make part of the one or more processes, as one or more non-viewable processes that are not included in the information for display to be transmitted to the purchaser terminal.

17. The information provision system according to claim 16, wherein the one or more non-viewable processes that are not included in the information for display include a process of waiting for arrival of a part and/or a process in a state waiting for allocation of a man-hour.

18. The information provision system according to claim 16, wherein the controller is configured to:
make information on the one or more non-viewable processes viewable from a dealer terminal provided at the automobile dealer; and
make the information on the one or more non-viewable processes sharable with a different automobile dealer.

19. The information provision system according to claim 10, wherein
the memory is configured to store information on function description associated with each process of the one or more processes, and
the controller is configured to transmit the information on the function description to the purchaser terminal upon accepting, from the purchaser terminal, a request for the information on the function description of the one or more processes.

20. An information provision method performed by a controller of an information provision apparatus, the information provision method comprising:
storing, in a memory, information on a vehicle stored in an automobile dealer before delivery to a purchaser, in association with identification information assigned to the vehicle;
upon accepting, from a purchaser terminal, an information request including the identification information, generating or acquiring schedule information including one or more processes that are scheduled up to the delivery, to the purchaser, of the vehicle to which the identification information is assigned;
generating information for display to be displayed to the purchaser, and transmitting the information for display to the purchaser terminal,
wherein the information for display includes information on a progress status in the one or more processes and information describing the one or more processes.
